(19) United States
(12) Patent Application Publication
(10) Pub. No.: US 2005/0195137 A1
(43) Pub. Date: Sep. 8, 2005

(54) Sequential color modulation method in display systems

(76) Inventors: Peter Richards, San Francisco, CA (US); Michel Combes, Santa Cruz, CA (US)

Correspondence Address: REFLECTIVITY, INC., 350 POTRERO AVENUE, SUNNYVALE, CA, 94085, US

(21) Appl. No.: 11/120,457

(22) Filed: May 2, 2005

Related U.S. Application Data
(63) Continuation-in-part of application No. 10/771,231, filed on Feb. 3, 2004.

(51) Int. Cl. G09G 3/34

(52) U.S. Cl. 345/84

(57) ABSTRACT

Disclosed herein is method and apparatus for operating spatial light modulators using pulse-width-modulation techniques. With the method and apparatus disclosed herein the vast majority of sequential color light beams can be utilized without sacrificing the color saturation of the images to be displayed.

### CROSS-REFERENCE TO RELATED CASES

The present patent application is a continuation-in-part of U.S. patent application Ser. No. 10/771,231 filed Feb. 3, 2004, the subject matter being incorporated herein by reference.

### TECHNICAL FIELD OF THE INVENTION

The present invention is related generally to display systems employing spatial light modulators, and, more particularly, to apparatus and method of sequential color modulation methods thereof.

### BACKGROUND OF THE INVENTION

In display systems employing spatial light modulators, such as liquid-crystal-display (LCD), liquid-crystal-on-silicon (LCOS), and microelectromechanical system (MEMS)-based display systems, color images are often produced using sequential-color techniques, in which primary color (red, green, and blue) light are sequentially applied to the spatial light modulator. The pixels of the spatial light modulator modulate the primary color light with image data corresponding to the primary color being modulated so as to generate a color component of the desired image. In sequential color applications, color filters, such as color wheels, are generally used. A color wheel may have many segments each of which passes light of a particular waveband, such as red light, or green light or blue light. By directing a beam of light onto a color wheel that spins around a shaft, primary color light beams are sequentially produced.

In accordance with such produced primary colors, a color image is represented by sets of image data with each set representing a primary color component of the image. During a time interval when the pixels of the spatial light modulator are illuminated by a primary color (e.g. red), image data for the primary color (e.g. image data for the red color) is written to the pixels of the spatial light modulator so as to produce the primary color component of the image. The image data can be written in many ways, such as a pulse-width-modulation scheme. During a frame period, all three primary color components of the image are produced and integrated together by human eyes so as to produce the image.

In such color light sequence, however, there are time intervals during which a combination of the primary colors (e.g. red and green, or green and blue, or blue and red) is incident on areas of the pixels of the spatial light modulator simultaneously. This occurs when the spokes of the color wheel pass through the output of either the arc lamp (when the color wheel is positioned immediately after the arc lamp) or a lightpipe (when the lightpipe is positioned between the arc lamp and color wheel). This phenomenon is often referred to as “color transition”. The time interval that a spoke sweeps across the output of the arc lamp or the lightpipe, or equivalently, the time interval that all pixels of the spatial light modulator experience the color transition once is often referred to as “color transition period”. In current display systems, the primary colors illuminating the pixels of the spatial light modulator during the color transition period are either dumped or used as components of white color for high brightness or a combined secondary color. In the situation where the primary colors are dumped, optical efficiency of the display system is degraded. In the situation when the spoke light beams are used as components of white color, color saturation of the image is sacrificed.

Therefore, what is needed is a sequential illumination method and apparatus for operating spatial light modulators of display systems. With the method and apparatus disclosed herein the vast majority of sequential color light beams can be utilized without sacrificing the color saturation of the images to be displayed.

### SUMMARY OF THE INVENTION

In view of the foregoing, the present invention provides a method and apparatus for operating spatial light modulators. In one embodiment, a method of operating a spatial light modulator comprising an array of pixels using a pulse-width-modulation technique is disclosed. The method comprises: generating a set of bitplanes based on a pulse-width-modulation technique and a set of bits assigned for representing the grayscale of a desired image; determining a first loaded bitplane; splitting the first loaded bitplane into first and second portions; updating the pixels of the pixel array with the first portion but not the entire first loaded bitplane; sequentially updating the pixels of the pixel array with the generated bitplanes; and updating the pixels of the pixel array with the second portion of the first loaded bitplane. The objects of the invention are achieved in the features of the independent claims attached hereto. Preferred embodiments are characterized in the dependent claims.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 schematically illustrates a display system in which embodiments of the invention can be implemented;

FIG. 2A illustrates an exemplary color wheel that can be used in the display system of FIG. 1;

FIG. 2B illustrates another exemplary color wheel that can be used in the display system of FIG. 1;

FIG. 2C illustrates yet another exemplary color wheel that can be used in the display system of FIG. 1

FIG. 3 illustrates a illumination scheme of the pixels of the spatial light modulator during a color transition period;

FIG. 4 is an exploded diagram schematically illustrating the pixel that are illuminated by a combination of red and green primary colors;

FIG. 5 schematically illustrates an exemplary illumination scheme of the spatial light modulator according to an embodiment of the invention;

FIG. 6 schematically illustrates another exemplary illumination scheme of the spatial light modulator according to an embodiment of the invention;

FIG. 7 illustrates a method of updating pixels in a spatial light modulator for a exemplary color field; and

FIG. 8 demonstratively illustrates a method of updating the spatial light modulator by updating the even and odd numbered rows separately.

### DETAILED DESCRIPTION OF THE INVENTION

The present invention provides an illumination system for providing sequential color light beams. The illumination system comprises a light source, a lightpipe, and a color filter that is positioned after the lightpipe within the propagation path of the illumination light such that primary color light beams shining on the spatial light modulator have defined boundaries during color transition periods.

In operation, a frame period is divided into primary color periods and color transition periods, each color transition period further comprising a set of spoke periods. During a primary color period, the pixels of the spatial light modulator are illuminated by one primary color. During a color transition period, the pixels of the spatial light modulator are sequentially illuminated by a combination of the primary colors. Because the combination of the primary colors has a defined boundary when illuminating the pixels of the spatial light modulator, such a boundary sequentially sweeps across the rows of the pixel array of the spatial light modulator during a color transition period. Accordingly, a spoke period is defined for a row of pixels as the time interval that the row of pixels is swept by a spoke. The spoke periods within a color transition period vary with the position of the rows. Specifically, the spoke periods within a color transition period for different rows start and end at different times, and the duration of the spoke periods may change with the rows.

During a primary color period, the pixels of the spatial light modulator modulate the primary color light beam with image data corresponding to the primary color. During a color transition period when a combination of primary colors is incident on the array of the spatial light modulator, the rows of pixels not in their spoke periods respectively modulate the primary colors of the combination; while the rows of pixels in their spoke period are set to the OFF state.

During a primary color period, bitplane date of the primary color are loaded into the pixels illuminated by the primary color. To match the speeds of bitplane data update and color transition to the adjacent color field, a bit of the pulse-width-modulation is split into sub-bits. The bitplane data of such split bit are loaded more than once during said primary color period.

During each primary color period, the pixels of the spatial light modulator can be updated separately. Specifically, the pixel array of the spatial light modulator can be divided into groups. Different groups of pixels are provided with separate wordlines (and/or bitlines). With this configuration, different groups of pixels can be updated out of phase. In particular, the even and odd numbered rows of pixels can be updated at different phases.

In the following, the present invention will be discussed by way of specific examples. Those skilled in the art will certainly appreciate that the following discussion is for demonstration purposes only and should not be interpreted as a limitation on the scope of the invention.

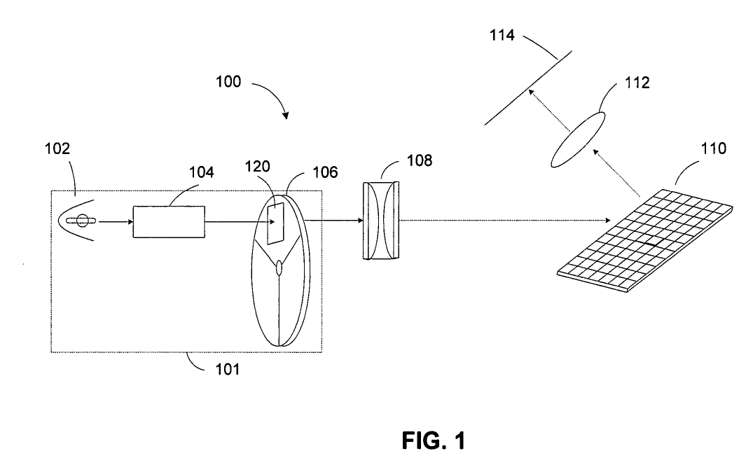

Referring to FIG. 1, an exemplary display system is illustrated. In its basic configuration, display system 100 comprises illumination system 101 for producing sequential color light, spatial light modulator 110, projection lens 112, and display target 114. Other optics, such as condensing lens 108 could also be installed if desired.

Illumination system 101 comprises light source 102, which can be an arc lamp, lightpipe 104 that can be any suitable integrator of light or light beam shape changer, and color filter 106, which can be a color wheel. It is worthwhile to point out that the color wheel is positioned after the light source and lightpipe on the propagation path of the illumination light from the light source.

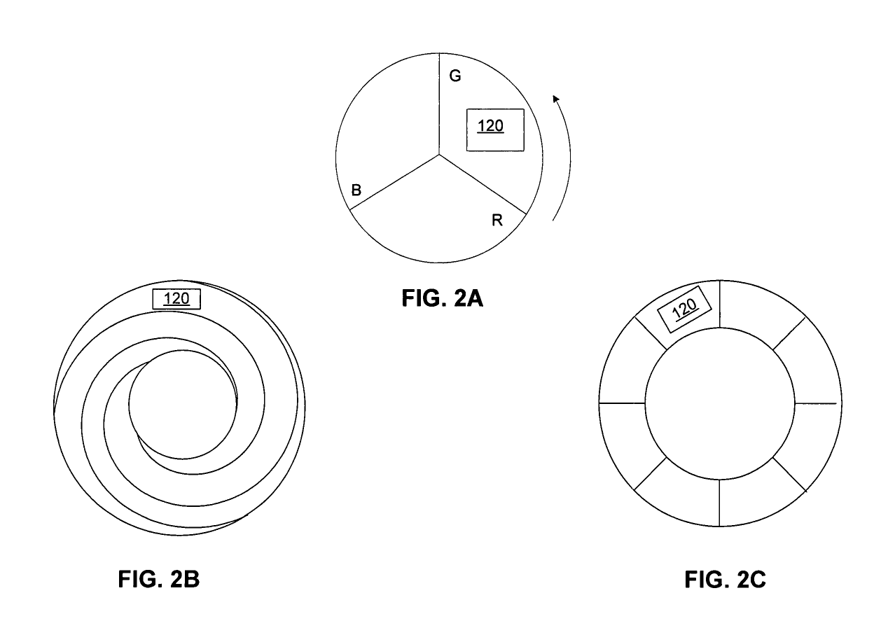

The color wheel can be of many different configurations, one of which is illustrated in FIG. 2A. Referring to FIG. 2A, the color wheel in this particular example comprises three segments R, G, and B. Each segment passes light of a particular waveband. Specifically, the R segment passes red light; the G segment passes green light; and the B segment passes blue light. In another example, the color wheel may comprise more than three segments, such as a white segment can be provided in addition to the R, G, and B segments. In yet another example, instead of having only one segment for one of the three primary colors, the color wheel may have a plurality of segments for a primary color (e.g. RGBRGB or RGBRGBRGB), in which situation, the total number of segments is preferably less than 40, more preferably less than 30, more preferably less than 24, such as 12 or fewer. When multiple segments are provided for the same primary color, the multiple segments may not be uniformly distributed. For example, the areas of the multiple segments for the same primary color can be different. Rather than the three primary colors—red, green, and blue, the segments of the color wheel may be designed for passing other color combinations. For example, the color wheel may have segments that respectively pass yellow, cyan, and magenta (or both red, green, and blue, as well as yellow, cyan and magenta).

FIG. 2B schematically illustrates another exemplary color wheel. The spokes of the color wheel have spiral shapes, such as the Archimedean spiral. The primary colors; or selected colors (e.g. yellow, cyan, and magenta) are distributed between the spiral spokes. FIG. 2C schematically illustrates yet another exemplary color wheel that can be used in the present invention. The color wheel ring has many segments in which the primary colors or selected colors (e.g. yellow, cyan, and magenta) are distributed.

The light beam from the output opening of lightpipe 104 illuminates only a portion of the color wheel, as shown in FIG. 1. The illumination area on the color wheel is illustrated by window 120 in FIGS. 2A, 2B, and 2C. As an example of the invention, illumination area 120 has a size that is smaller than the area of any segment of the color wheel or a length of a color wheel segment is not less than half, preferably not less than the entire length (or width) of the pixel array of the spatial light modulator (whichever corresponds to the columns of the array). As a result, the light from the lightpipe illuminates at most two segments at a time as the color spins around its shaft in operation.

The spatial light modulator may comprise an array of microscopic mirrors (these can be any size, though generally less than 20 micrometers in length), as set forth in U.S. Pat. Nos. 6,046,840 and 6,172,797; and U.S. patent applications Ser. No. 10/366,296 to Patel, filed Feb. 12, 2003; Ser. No. 10/366,297 to Patel, filed Feb. 12, 2003; Ser. No. 10/627,155 to Patel, filed Jul. 24, 2003; Ser. No. 10/613,379 to Patel, filed Jul. 3, 2003; Ser. No. 10/437,776 to Patel, filed May 13, 2003; and Ser. No. 10/698,563 to Patel, filed Oct. 30, 2003, the subject matter of each being incorporated herein by reference. The spatial light modulator may also be transmissive liquid crystal type display, reflective liquid crystal type display or another type of spatial light modulator. Upon receiving the sequential color light beams, the pixels of the spatial light modulator individually modulates the light beams with the image data so as to generate the image on the display target. Specifically, each pixel operates in an ON and OFF state. A light beam is reflected by a pixel towards projection lens 112 in FIG. 1 so as to create a “bright” pixel in display target 114 when the pixel is in the ON state. In the OFF state, the pixel reflects the light away from the projection lens so as to create a “dark” pixel in the display target. Operation of the pixels is controlled by electrodes and memory cells of the pixels. In addition to digitally operated spatial light modulators, the spatial light modulator can also be analog spatial light modulators, such as analog mirror array, transmissive liquid crystal type display or analog reflective liquid crystal type display.

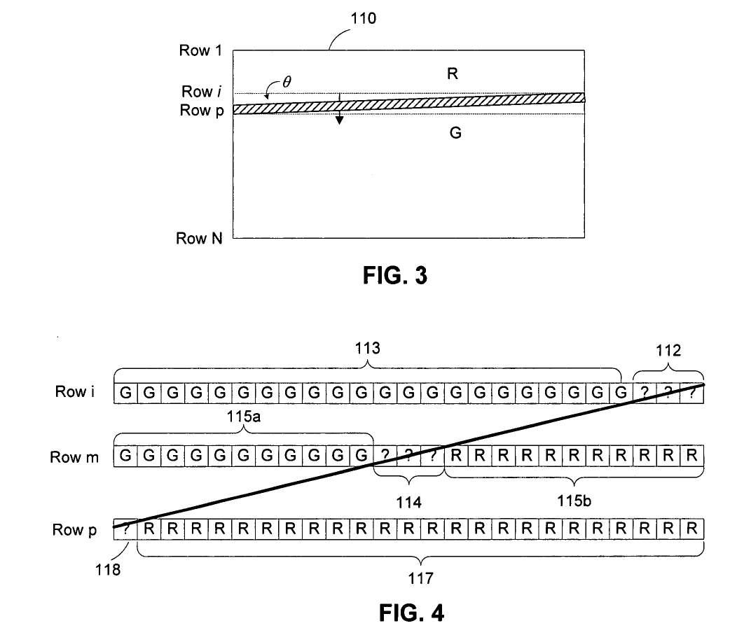

The sequential primary color light beams from the color wheel sequentially illuminate the pixels of the spatial light modulator during a frame period. When the illumination area (e.g. illumination area 120 in FIGS. 1 and 2A) is within a segment of a primary color, the pixels of the pixel array in the spatial light modulator are illuminated with the primary color. As the color wheel spins during operation, the illumination area sweeps across different segments of the color wheel, resulting in color variation of the light shining on the pixels of the spatial light modulator, as shown in FIG. 3.

Referring to FIG. 3, the spoke (represented by the shaded bar) sweeps from the top to bottom of the pixel array as the color wheel spins during the operation. Alternatively, the spoke can sweep from the bottom to top of the pixel array by reversing the spin direction of the color wheel. Because of the angular movement of the color segment boundaries relative to the static illumination area 120 on the color wheel (which is the image of the exit aperture of the light pipe), the spoke has an angle θ to the rows of the pixel array.

At a particular time, the spoke between the G and R segments of the color wheel lies within illumination area 120 of the color wheel (e.g. as illustrated in FIG. 2A). Because the color wheel is positioned behind the light pipe, the green and red color beams on the spatial light modulator present a boundary. As a result, pixels of the rows from 1 to i of the array are illuminated by the red color light. Rows from i to p are illuminated by a combination of red and green color light beams. The number of rows between the rows i and p is determined, among other factors, by the segment and the illumination area. Pixels of the rows from p to N (wherein the pixel array of the spatial light modulator is assumed to have total number of N rows) are illuminated with the green color light.

As a way of example, the illumination scheme of the pixel rows from i to p is illustrated in FIG. 4. Referring to FIG. 4, the pixels of the rows from i to p are illuminated by red and green colors simultaneously, wherein the boundary of the red and green colors is represented by the solid line that spans across the rows from i to p. Pixels of row i are illuminated by green colors except pixels 112 of the row. The color of the illumination light on pixels 112 is undeterminable due to many facts, such as the fact that the red and green color light beams may be mixed from light scattering in these pixels. For the same reason, the color of the illumination light on pixels 114 in row m is undeterminable. The pixels on the left side of pixels 114 in row m are illuminated by green light, while the pixels on the right side of pixels 114 in the row are illuminated by the red color light. For the pixels in row p, pixel 118 has an undeterminable color, while the other pixels of the row are illuminated by the red color light. As the color wheel spins during operation, the boundary sweeps across the pixel rows over time; and the pixel rows change from one color to another. The slope of the boundary also varies from the top to the bottom of the pixel array. Specifically, the slope of the boundary at the top of the pixel array is greater than the slope of the boundary at the bottom of the pixel array, though this depends upon the orientation of the spatial light modulator to the spokes of color wheel.

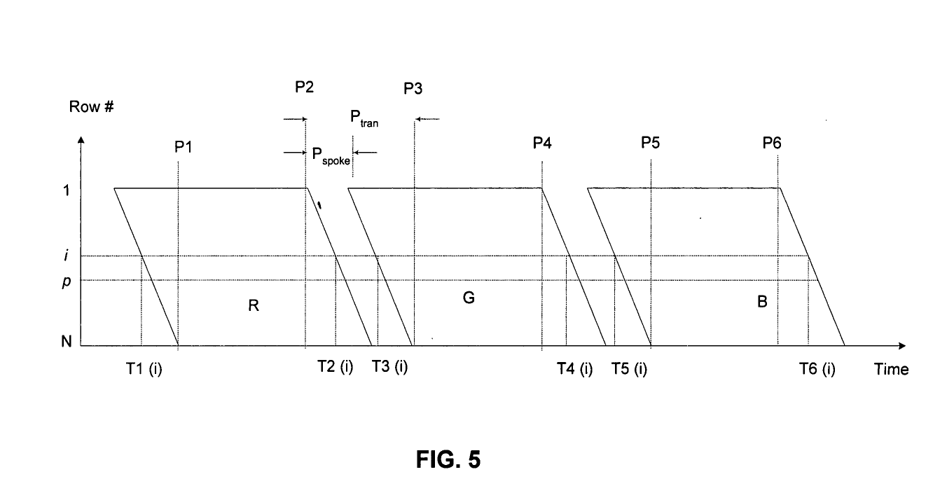

Referring to FIG. 5, an exemplary illumination scheme for the pixel array in the spatial light modulator is illustrated therein. The rows of the pixel array of the spatial light modulator are plotted in the Y-axis; and the time is plotted in the X-axis. Primary color light beams red, green, and blue sequentially illuminate the pixel array of the spatial light modulator during each frame period. In this particular example, primary colors red, green, and blue are produced to illuminate the pixels of the spatial light modulator. Other colors, such as yellow, cyan, and magenta colors may also be used if the segments of color wheel are designed accordingly.

According to the invention, a frame period is divided into primary color periods and color transition periods. Each color transition period further comprises a set of spoke periods. During a primary color period, the pixels of the spatial light modulator are illuminated by one primary color. As shown in FIG. 3, time intervals from P₁ to P₂, from P₃ to P₄, from P₅ to P₆ are primary color periods. Time intervals from P₂ to P₃, and P₄ to P₅ are color transition periods, during each of which a combination of primary colors sweep across the pixel array from row 1 to row N.

Specifically, during the color transition period from P₂ to P₃, a combination of red and green colors sweeps across the rows of the pixel array from row 1 to row N. During the color transition period from P₄ to P₅, a combination of green and blue colors sweeps across the rows of the pixel array from row 1 to row N. Because the combination of the primary colors has a defined boundary when illuminates the pixels of the spatial light modulator, such a boundary sequentially sweeps across the rows of the pixel array of the spatial light modulator during a color transition period. Accordingly, a spoke period can be defined for a row of pixels as the time interval that the row of pixels is swept by a spoke. The spoke periods within a color transition period vary with positions of the rows. Specifically, the spoke periods within a color transition period for different rows start and end at different times, and the duration of the spoke periods may change with the rows. For example, for the i^{th} row, the spoke period is from T₂(i) to T₃(i). For the (i+1)^{th} row, the spoke period of this row starts from T₂(i+1), which is one unit time behind T2(i); and the spoke period of this row ends at T₃(i+1), which is one unit time behind T₃(i).

With such sequential color light beams, the present invention provides a modulation algorithm for modulating the light shining on the pixels of the spatial light modulator so as to displaying color images. During each primary color period (e.g. periods from P₁ to P₂, P₃ to P₄, and P₅ to P₆), image data of the primary color are loaded to the pixels illuminated by the primary color. In order to produce the perception of a gray-scale or full color image in such a display system, it is necessary to rapidly modulate the pixels between “ON” and “OFF” states such that the average over a time period (e.g. the time period corresponds to the critical flicker frequency) of their modulated brightness corresponds to the desired “analog” brightness for each pixel. This technique is generally referred to as pulse-width-modulation (PWM). Above a certain modulation frequency, the viewer eyes and brain integrate a pixel's rapid varying brightness and perceived brightness determined by the pixel's average illumination over a period of time.

According to the pulse-width-modulation, image date of the desired images are formatted into bitplane data compliant with certain pulse-width-modulation wave format, such as binary and non-binary wave formats, equal and non-equal length wave formats. In the following discussion, a binary wave format is used, while the invention is applicable in other wave formats.

The modulation can be performed for all pixels at a time of the array by updating the pixels with the corresponding image data. Alternatively, the modulation can also be performed by writing the corresponding image data to the rows of the array sequentially. In performing pulse-width-modulation, artifacts, such as color separation and/or dynamic false contour may be generated. To avoid these artifacts, the pixels in each row of the array or the rows of pixels can be updated at different time intervals, as set forth in U.S. patent application Ser. No. 10/407,061 to Richards, filed Apr. 2, 2003, the subject matter being incorporated herein by reference.

During the color transition periods, even though some pixel rows (e.g. rows from i to p) are illuminated by a combination of primary colors, the other pixel rows (e.g. rows from 1 to i and from p to N) are still illuminated by only one primary color. Therefore, these rows of pixels illuminated by only one primary color can keep on modulating the primary color. Because the pixels of these rows experience color transitions at different times, light modulation by these pixels is scheduled at different times. For example, during the primary color period from P₁ to P₂, the pixels of the i^{th} row modulate the red light beam using a pulse-width-modulation technique. During the time interval from P₂ to T₂(i), the pixels in the i^{th} row keep on modulating the red color light beam. At T₂(i), the pixels of the i^{th} row can be set to the OFF state till T₃(i). At T₃(i), the pixels of the i^{th} row are illuminated by the green color light only. Therefore, the pixels of the i^{th} row start to modulate the green light using the pulse-width-modulation method till time P₃. During the primary color period from P₃ to P₄, the pixels of the i^{th} row may perform the pulse-width-modulation along with all other pixels of the array.

The modulation algorithm for the pixel of the i^{th} row as discussed above are applied to other pixels. For example, during the primary color period from P₁ to P₂, the pixels of the (i+1)^{th} row modulate the red light beam using a pulse-width-modulation technique. During the time interval from P₂ to T₂(i+1) that is one unit time later than T₂(i), the pixels in the (i+1)^{th} row keep on modulating the red color light beam. At T₂(i+1), the pixels of the (i+1)^{th} row can be set to the OFF state till T₃(i+1). It is clear that, the pixels of the (i+1)^{th} row are set to the OFF state at a time one unit time later than the pixels of the i^{th} row, but set to the OFF state for the same time interval. At T₃(i+1), the pixels of the (i+1)^{th} row are illuminated by the green color light only. Therefore, the pixels of the (i+1)^{th} row start to modulate the green light using the pulse-width-modulation method till time P₃.

In the above discussed examples, all pixels of the rows in the spoke periods are set to the OFF state, such as the pixels in rows from i to p in FIG. 2E. Alternatively, the individual pixels having a single primary color may also be operated to modulate primary colors. Referring back to FIG. 4, pixels 113 in row i illuminated by green color can modulate the green color light beam with the corresponding image data, while pixels 112 are set to the OFF state. For row m, pixels 115a and 115b are respectively illuminated by green and red colors. Accordingly, pixels 115a and 115b may modulate the green and red colors respectively, while pixels 114 are set to the OFF state. Since pixels 117 in row p are illuminated by the red primary color, these pixels may modulate the red light beam with the corresponding image data. Pixel 118 is set to the OFF state. It can be seen that, this modulation algorithm best utilizes the illumination color by individually blanking (setting to the OFF state) the pixels having uncertain or mixed colors.

In implementing the modulation algorithm, positions of the spokes sweeping across the pixel array is calculated from the optical configurations of the system, such as the relative positions of the exit aperture of the light pipe, color wheel, projection lens, and the pixel array, as well as the rotation speed of the color wheel. However, in some instances, the spokes in FIG. 5 do not have clear boundaries that exactly match the physical transitions of the boundaries of the color fields in the color wheel. For example, because the exit aperture of the light pipe (e.g. lightpipe 104 in FIG. 1) is often spaced apart from the surface of the color wheel (e.g. color wheel 106) as shown in FIG. 1, the spokes on the pixel array may not perfectly match the physical boundaries of the color fields on the color wheel. As a result, the boundaries of the spokes on the pixel array are blurred. This problem can be solved by substituting each spoke with a spoke band that includes the spoke and the area (rows) in the vicinity of the spoke. As a way of example, in a system wherein the color wheel rotates at an angular frequency of 120 Hz; and the spatial light modulator comprises 1024×768 or higher, a spoke band may comprise 192 rows of pixels.

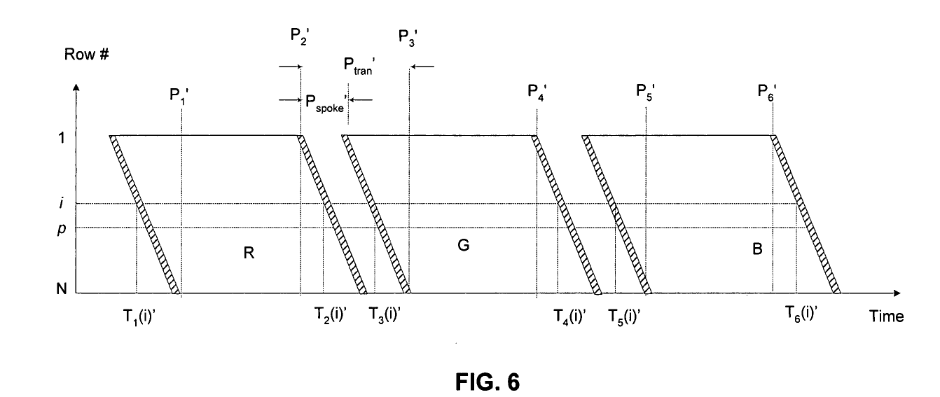

FIG. 6 demonstratively illustrates a sequence of color fields sweeping through the pixel array, with spoke bands between the adjacent color fields. Each spoke band comprises a spoke and blurred rows (shaded regions). The number of blurred rows (the area of the shaded regions) can be pre-determined by user. In accordance with an embodiment of the invention, a spoke band comprises two tenth or less, such as one tenth or less of the total number of rows in the pixel array. Alternatively, a spoke band may comprise blurred rows with a total number from 10 to 150, or from 30 to 130, or from 10 to 110, or around 50.

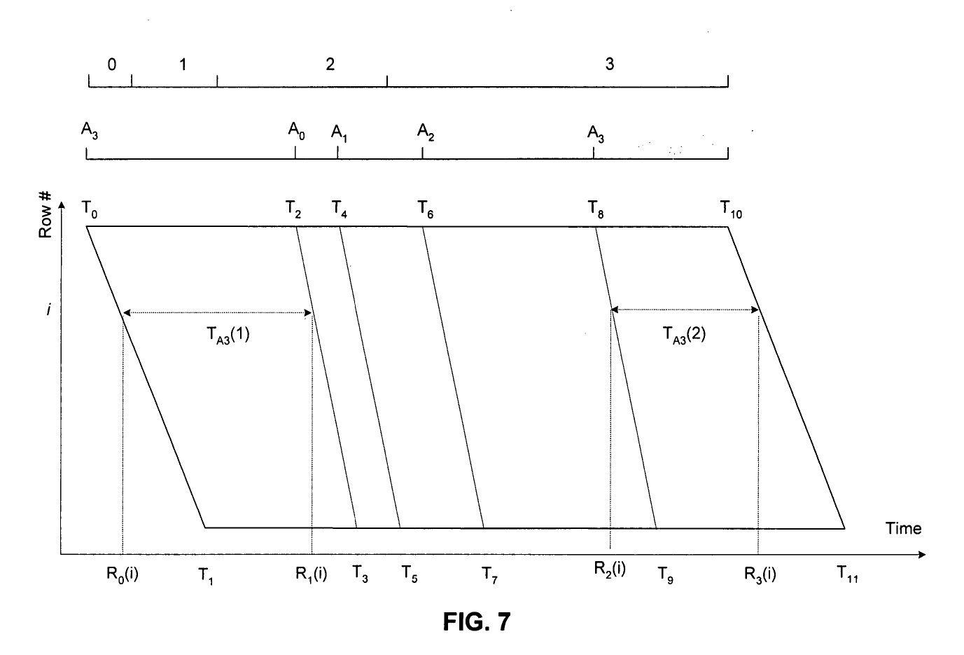

During each primary color period, pixels illuminated by the primary color are updated by the bitplane data of the primary color. However, the update speed may not be synchronized by the speed of the spoke transition. As a result, undesired extra weights are introduced to the bitplanes—yielding undesired artifacts, as shown in FIG. 7.

Referring to FIG. 7, a primary color field (e.g. red color) sweeps through the pixels of the spatial light modulator. Such primary color is modulated by the pixels according a pulse-width-modulation technique. The binary wave form format according to the pulse-width-modulation is shown on the top of the figure, wherein 4 bits are assigned to represent the gray-scale of the image for demonstration purposes. Of course, other number of bits can be assigned to represent the gray-scale of the image. The image data of the desired image are formatted based on the defined wave form shown in the figure.

During the primary color period, all bitplane data of the primary color are loaded into the pixels sequentially. The bitplane data can be loaded in many ways. The bitplane data can be loaded sequentially according to their weights, for example in an order of bitplanes 0, 1, 2, and 3. Alternatively, the bitplane data can be loaded in any order. As shown in the figure, pixels of the pixel array can be updated by the bitplane data in an order of bit planes of 3 (A₃), 0 (A₀), 1 (A₁), and 2 (A₂). Specifically, Starting at T₀ and during the interval from T₀ to T₁, pixel rows are updated with bitplane A₃. During the following time intervals from T₂ to T₃, T₄ to T₅, T₆ to T₇, and T₈ to T₉, the pixels rows are updated with bitplanes A₀, A₁, and A₂, respectively.

Because the updating rate is different from the rate corresponding to the speed of the spoke, different pixel rows of the pixel array experience different durations of the same first loaded bitplane (e.g. bitplane A₃). In another word, the designated weight of the first loaded bitplane is unexpectedly changed. For example, the pixels in the i^{th} row are updated with the first loaded bitplane A₃ for a time interval longer than the time interval during which the pixels in the p^{th} row are updated with the same bitplane (A₃). This unexpected extra artifact can be corrected by splitting the bit of the first loaded bitplane into sub-bits, and the first loaded bitplane is re-loaded at the end, as shown in the figure. As a result, the summation of the durations of the first loaded bitplane and the last re-loaded same bitplane for the same row is substantially equal to the designated duration of the bitplane.

As a way of example, bitplane A₃ is loaded to the pixels in the i^{th} row for a time period of T_{A3}(1) (from R₀(i) to R₁(i)) at the start of the primary color period. At the expiration of T_{A3}(i), bitplane A₀ is loaded for a time period corresponding to the weight of the bitplane (1^{st} bitplane). At the expiration of the time period corresponding to the bitplane A₀, bitplane A₁ is loaded for a time interval corresponding to the bitplane of A₁. After the expiration of the time period of bitplane A₁, bitplane A₂ is loaded for a time interval corresponding to the bitplane A₂. At the expiration of the designated time period of A₂, bitplane A₃ is re-loaded till the arrival of the next spoke. The total amount of time interval of the first loaded bitplane A₃ on the pixels (T_{A3}(1)+T_{A3}(2)) is substantially equal to the designated time period of the bitplane A₃.

In the above example, bitplane A₃ is loaded first; and the bit corresponding to the bitplane A₃ is split into two sub-bits. The duration (T_{A3}(1)) of the first loaded bitplane (e.g. A₃) can be of any suitable value, but less than the designated duration of the bitplane (A₃). Alternatively, other bitplanes than A₃ which corresponds to the MSB can be loaded first. However, such first loaded bitplane is preferable not the LSB.

With the above discussed PWM algorithm, usage of the pure (monochromatic) colors can be significantly improved. As a numerical example, usage of the pure colors in the display system in FIG. 1 wherein the color wheel is disposed after the lightpipe at the propagation path of the illumination light can be mathematically expressed as:

$$η = \frac{360 - {N}_{seg} \times spoke \text{-} width}{360} \qquad Eq . 1$$

wherein N_{seg} is the number of color segments in the color wheel; and spoke-width can be expressed as:

$$spoke \text{-} width = \frac{aperture}{m} \qquad Eq . 2$$

wherein aperture is the solid angle of the illumination light from the light source to the illuminated area in the color wheel; m is a constant. A typical value of m can be 4. Of course, m can take any other suitable values, such as 3, 5, 6, or even larger. When m is 4, the usage η can be 98.1% with the aperture being 6.5° degrees, and η can be 96.1% with the aperture being 13.82° degrees. As a comparison, the usage of the pure colors η without the present invention can be calculated by:

$$η = \frac{360 - {N}_{seg} \times aperture}{360} \qquad Eq . 2$$

For the same color wheel (same number and configuration of the color segments) and the same value of the aperture, the usage of the pure colors η without the present invention is 92.7% for the aperture of 6.5° degrees, and is 84.6% for the aperture of 13.82° degrees. By adjusting the values of m, aperture, and total number of segments, different usages of the pure colors can be achieved. According to the invention, the usage η is preferably 96% or more, 98% or more, or 99% or more.

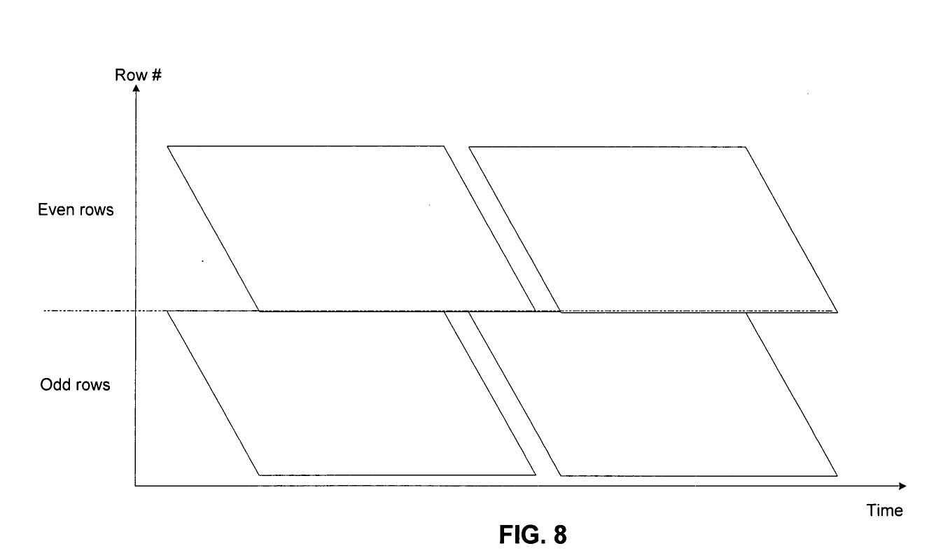

In addition to the image data updating method discussed above with reference to FIGS. 5 to 7, the pixel array of the spatial light modulator can be updated in groups, as shown in FIG. 8. Referring to FIG. 8, even and odd pixel rows can be updated at different phases. Specifically, the even and odd numbered pixel rows can be updated according to different sequences. Such updating scheme allows for speeding up the transition, but without impacting the bandwidth of the system (e.g. the bandwidth of the data transmission in the system). The data updating scheme as shown in FIG. 8 can be generalized into any groups of pixel rows, while different pixel groups may or may not have the same number of pixel rows. In operation, different groups of pixel rows can be updated at different times according to different updating sequences.

It will be appreciated by those of skill in the art that a new and useful method and apparatus for operating spatial light modulators of display systems have been described herein. In view of the many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

1. A method of operating a spatial light modulator comprising an array of pixels using a pulse-width-modulation technique, the method comprising:
generating a set of bitplanes representing a intensity of a desired image;
determining a first bitplane of the set of bitplanes;
splitting the first bitplane into first and second portions;
updating the pixels of the pixel array with the first portion but not the second portion of the first bitplane;
sequentially updating the pixels of the pixel array with a second bitplane of the set of bitplanes; and
updating the pixels of the pixel array with the second portion of the first bitplane.

2. The method of claim 1, wherein the step of generating the set of bitplanes further comprises:
assigning a weight to each of the bits assigned to represent the color intensity of the image according to a weight scheme comprising a binary weight scheme.

3. The method of claim 1, wherein the step of generating the set of bitplanes further comprises:
assigning a weight to each of the bits assigned to represent the color intensity of the image according to a non-binary weight scheme.

4. The method of claim 3, wherein the step of generating the set of bitplanes further comprises:
assigning a weight to each of the bits assigned to represent the intensity of the image according to a weight scheme comprising a equal-length weight scheme.

5. The method of claim 3, wherein the step of generating the set of bitplanes further comprises:
assigning a weight to each of the bits assigned to represent the intensity of the image according to a non-equal-length weight scheme.

6. The method of claim 1, further comprising:
sequentially illuminating the pixel array with a set of primary colors; and
wherein the step of generating the set of bitplane comprises:
generating a set of bitplanes for each one of the set of primary colors.

7. The method of claim 6, wherein the step of updating the pixels comprises:
updating the pixels of the pixel array by a set of pixel groups, each pixel group comprises a plurality of pixels.

8. The method of claim 7, wherein each group comprises a row of pixels; and wherein pixels in the same row are in the same group.

9. The method of claim 6, wherein the primary colors illuminates the pixel array from the top to the bottom of the pixel array.

10. The method of claim 6, wherein the primary colors illuminates the pixel array from the bottom to the top of the pixel array.

11. The method of claim 7, wherein the pixel groups of the pixel array are updated from the top to the bottom.

12. The method of claim 7, wherein the pixel groups of the pixel array are updated from the bottom to the top.

13. A method of operating an array of pixels of a spatial light modulator, comprising:
providing light from a light source to be incident on the array of pixels;
directing the light from the light source through a rotary color filter so as to obtain first and second colors that exhibit a spoke on the pixel array;
sequentially illuminating the pixels with the first and second colors by sweeping the first and second colors across the pixel array, wherein the spoke sweeps at a X rows per second; and
updating the pixels with a set of image data at an updating rate of Y rows per second that is different from X.

14. The method of claim 13, wherein the step of updating the pixels further comprises:
updating a first row of the array at a first updating rate; and
updating a second row of the array at a second updating rate.

15. The method of claim 13, wherein the image data are composed of a set of bitplanes derived from a pulse-width-modulation algorithm, each said bitplane being assigned to a weight representing a time interval for which said bitplane is to be maintained at the pixels.

16. The method of claim 15, wherein the bitplanes are assigned to weights according to a binary weight scheme defining a MSB and LSB, wherein a bitplane of MSB has the longest time interval in the pixels, and a bitplane of LSB has the least time interval in the pixels.

17. The method of claim 16, wherein the bitplane of the MSB is split into first and second portions that are respectively loaded to the pixels at the start and end of a step of updating the pixels with the set of bitplanes.

18. The method of claim 17, wherein the bitplanes are derived for one monochromatic color of a set of monochromatic colors

19. The method of claim 18, wherein the set of monochromatic colors comprises red, green, and yellow.

20. The method of claim 18, wherein the set of monochromatic colors comprises cyan, yellow, and magenta.

21. The method of claim 16, wherein the binary weight scheme further defines an intermediate bit weight between the MSB and LSB; and wherein a bitplane with said intermediate weight is split into first and second portions that are respectively loaded to the pixels at the start and end of a step of updating the pixels.

22. The method of claim 13, wherein the step of directing the light from the light source through a rotary color wheel further comprises:
delivering the light from the light source to the color wheel through a lightpipe that is disposed between the light source and color wheel.

23. A method of producing an image using an array of pixels of a spatial light modulator, the method comprising:
directing light from a light source through a movable color filter having first, second, and third color segments;
rotating the color filter such that the first, second and third color segments are sequentially illuminated by the light for time periods of Tr, Tg and Tb so as to obtain first, second and third colors;
sequentially sweeping the pixel array with the first, second and third colors;
deriving, from the image, first, second and third sets of bitplanes such that the pixels illuminated by the first, second and third colors are to be updated with the first, second, and third sets of bitplanes, respectively; and
wherein the pixels are updated with the first, second and third sets of bitplanes for a time period that is 96% or more of the summation of Tr, Tg, and Tb.

24. The method of claim 23, wherein at 98% or more of the first monochromatic color is associated with the bitplanes of the first set of bitplanes.

25. The method of claim 24, wherein the first and second monochromatic colors are from a set of monochromatic colors comprising red, green, and blue.

26. The method of claim 24, wherein the first and second monochromatic colors are from a set of monochromatic colors comprising cyan, yellow, and magenta.

27. A method of operating an array of pixels of a spatial light modulator, comprising:
directing light from a light source through a movable color filter comprising first and second color segments;
rotating the color filter such that the first and second color segments are sequentially illuminated by the light so as to obtain first and second colors;
sequentially illuminating the pixels with the first and second colors by sweeping the first and second colors across the pixel array; and
updating the pixels with a set of image data at rates of X Hz and Y Hz at the same time period.
